(19) United States
(12) Patent Application Publication
(10) Pub. No.: US 2023/0006566 A1
(43) Pub. Date: Jan. 5, 2023

(54) DC-DC CONVERTER

(71) Applicant: LG INNOTEK CO., LTD., Seoul (KR)

(72) Inventors: Kwang Soon JUNG, Seoul (KR); Kyung Hyun KIM, Seoul (KR); Soo Hong KIM, Seoul (KR); Kyung Rae CHO, Seoul (KR)

(73) Assignee: LG INNOTEK CO., LTD., Seoul (KR)

(21) Appl. No.: 17/779,744

(22) PCT Filed: Nov. 17, 2020
(86) PCT No.: PCT/KR2020/016202

§ 371 Date: May 25, 2022

(30) Foreign Application Priority Data
Nov. 26, 2019 (KR) 10-2019-0153769

(51) Int. Cl. H02M 3/335; H02M 1/14

(52) U.S. Cl. CPC H02M 3/33592; H02M 1/14; H02M 3/33573

(57) ABSTRACT

A DC-DC converter according to an embodiment of the present invention comprises: a switch unit that receives a first DC voltage, separates the first DC voltage into three-phase voltages, and outputs the separated three-phase voltages; a transformation unit that transforms the three-phase voltages output from the switch unit, and outputs a three-phase output voltage; and a rectification unit that rectifies the three-phase output voltage applied from the transformation unit, and outputs a second DC voltage.

### TECHNICAL FIELD

The present invention relates to a DC-DC converter, and more specifically, to an isolated DC-DC converter using a Delta-Wye transformer.

### BACKGROUND ART

A voltage converter is a device that, when power having a specific voltage is supplied, converts the voltage to a voltage suitable for devices in various fields so that the voltage can be used immediately. The voltage converter includes a DC-DC converter, an AC-DC converter, and a DC-AC converter.

A DC-DC converter converts a DC voltage into a DC voltage of a different magnitude regardless of a change in an input voltage, and performs step-up or step-down. When a DC-DC converter outputs a large current in the process of converting a voltage, a bulky output inductor is required. In the case of the inductor, since the size is larger than that of other devices, the switch may be driven at a high frequency for miniaturization of the output inductor. In order to reduce the switching loss, a switch such as SiC or GaN may be applied, but there is a disadvantage in that the cost increases compared to the Si MOSFET. Therefore, there is a need for a converter capable of operating an output inductor at a high frequency at a low switching frequency.

### DETAILED DESCRIPTION OF THE INVENTION

### Technical Subject

The technical problem to be solved by the present invention is to provide an isolated DC-DC converter using a Delta-Wye transformer.

The problems of the present invention are not limited to the problems mentioned above, and other problems not mentioned will be clearly understood by those skilled in the art from the description below.

### Technical Solution

In order to solve the above technical problem, a DC-DC converter according to an embodiment of the present invention comprises: a switch unit that receives a first DC voltage which is to be separated and outputted as three-phase voltages; a transformation unit that respectively transforms the three-phase voltages outputted from the switch unit and outputs as three-phase output voltages; and a rectification unit that respectively rectifies the three-phase output voltages being applied from the transformation unit to output a second DC voltage.

In addition, it may further include a filter unit for smoothing the second DC voltage outputted from the rectification unit.

In addition, the filter unit may include one or more inductors and one or more capacitors.

In addition, the rectification unit may include three rectifiers respectively connected to output terminals of the transformation unit and one node to which output terminals of the three rectifiers are being connected.

In addition, each of the rectifiers may be respectively connected to each of (+) terminals at an output side of the transformation unit.

In addition, each of the rectifiers may be respectively connected to each of (−) terminals at an output side of the transformation unit.

In addition, the rectification unit may be comprised of one or more diodes or one or more MOSFETs.

In addition, the switch unit may include three switches, and the transformation unit may include three input terminals and three output terminals being respectively connected to the three switches.

In addition, the switch unit may include a first switch, a second switch and a third switch being connected in parallel; and a fourth switch being connected to the first switch, a fifth switch being connected to the second switch, and a sixth switch being connected to the third switch.

In addition, in the switch unit, the first switch and the fourth switch, the second switch and the fifth switch, and the third switch and the sixth switch may be complementarily conducted to each other.

In addition, in the switch unit, the first switch and the fourth switch, the second switch and the fifth switch, and the third switch and the sixth switch may be complementarily conducted to each other by controlling the duty ratio.

In addition, the switch unit may vary a voltage width being applied to the transformation unit by controlling a duty ratio of each switch.

In addition, the switch unit may vary the current and voltage values being outputted from the DC-DC converter by controlling the duty ratio of each switch.

In addition, each switch of the switch unit may have a predetermined dead time when it is switched from OFF to ON.

In addition, each switch of the switch unit may have a different phase.

In addition, the DC-DC converter may be a voltage-type DC-DC converter.

In order to solve the technical problem, the DC-DC converter according to another embodiment of the present invention includes: a switch unit; a transformation unit being connected to the switch unit; and a rectification unit being connected to the transformation unit, wherein the switch unit includes three switches, wherein the transformation unit includes three input terminals and three output terminals respectively being connected to the three switches, and wherein the rectification unit includes three rectifiers being connected to each of the output terminals of the transformation unit and one node to which the output terminals of the three rectifiers are being connected.

In order to solve the technical problem, a DC-DC converter according to another embodiment of the present invention comprises: a first switch, a second switch and a third switch being connected in parallel; a fourth switch being connected to the first switch, a fifth switch being connected to the second switch, and a sixth switch being connected to the third switch; a transformation unit including a first input terminal being connected to the first switch and the fourth switch, a second input terminal being connected to the second switch and the fifth switch, and a third input terminal being connected to the third switch and the sixth switch; a rectification unit being connected to the transformation unit; and a filter unit being connected to the rectification unit, wherein the rectification unit includes three diodes being connected to an output terminal of the transformation unit, and wherein the filter unit includes one input terminal being connected to the three diodes.

In order to solve the technical problem, the DC-DC converter according to another embodiment of the present invention comprises: a first switch, a second switch and a third switch being connected in parallel; a fourth switch being connected to the first switch, a fifth switch being connected to the second switch, and a sixth switch being connected to the third switch; a transformation unit including a first input terminal being connected to the first switch and the fourth switch, a second input terminal being connected to the second switch and the fifth switch, and a third input terminal being connected to the third switch and the sixth switch; a rectification unit being connected to the transformation unit; and a filter unit being connected to the rectification unit, wherein the rectification unit includes three MOSFETs being connected to an output terminal of the transformation unit, and wherein the filter unit includes one input terminal being connected to the three MOSFETs.

### Advantageous Effects

According to embodiments of the present invention, it is possible to reduce the current stress of the switch by dividing the input current to flow into three switches. The current stress of the rectifying switch can be reduced by also dividing the output current to flow into three switches. Through this, the output inductor can operate at three times the switching frequency, so that the output inductor can be operated at a high frequency even at a low switching frequency. Accordingly, the size of the output inductor can also be reduced.

The effect according to the present invention is not limited by the contents exemplified above, and more various effects are included in the present specification.

### BRIEF DESCRIPTION OF DRAWINGS

FIG. 1 illustrates a phase shift full-bridge converter (PSFB).

FIG. 2 illustrates a PSFB being driven with parallel switches.

FIG. 3 is a block diagram of a DC-DC converter according to an embodiment of the present invention.

FIG. 4 is a circuit diagram of a DC-DC converter according to an embodiment of the present invention.

FIGS. 5 to 8 are circuit diagrams of a DC-DC converter according to various embodiments of the present invention.

FIGS. 9 to 20 are diagrams for explaining the configuration and operation of a DC-DC converter according to an embodiment of the present invention.

FIG. 21 is a block diagram of a DC-DC converter according to another embodiment of the present invention.

FIGS. 22 and 23 are block diagrams of a DC-DC converter according to yet another embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

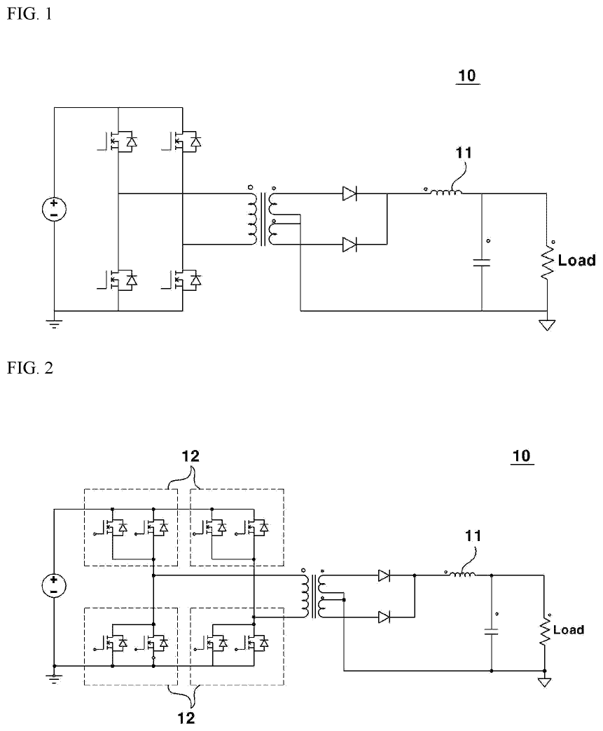

FIG. 1 illustrates a phase shift full-bridge converter (PSFB), and FIG. 2 illustrates a PSFB being driven with parallel switches.

A PSFB converter 10, which is a DC-DC converter, may be formed as shown in FIG. 1. A voltage inputted is applied to a transformer for voltage conversion using a half-bridge, and the voltage outputted from the transformer passes through a rectifier and a filter to output a transformed voltage. In this case, the inductor 11 positioned at the output stage may require a bulky output inductor according to the size of the output current.

In addition, in order to reduce the stress of a current flowing through the switch, as shown in FIG. 2, a plurality of switches may be formed 12 in parallel to be driven. In this case, losses occurring in the switch and the switch driving circuit increase according to the number of switches used in parallel, and it may be difficult to drive the converter at a high switching frequency in order to reduce the volume of the output inductor. A DC-DC converter according to an embodiment of the present invention can reduce the current stress of the switch as described above by using a three-phase transformer, and the size of the output inductor can also be reduced. Hereinafter, a DC-DC converter according to an embodiment of the present invention will be described in detail.

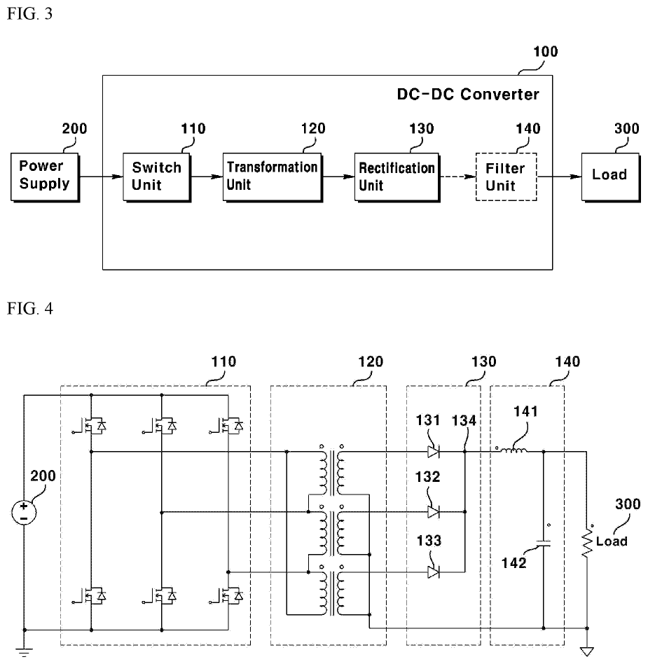

FIG. 3 is a block diagram of a DC-DC converter according to an embodiment of the present invention.

A DC-DC converter 100 according to an embodiment of the present invention includes a switch unit 110, a transformation unit 120, and a rectification unit 130, and may further include a filter unit 140.

The DC-DC converter 100 according to an embodiment of the present invention may be a voltage-type DC-DC converter. A voltage-type DC-DC converter is a converter that receives a voltage, transforms it and outputs it, and receives a DC voltage from a DC voltage source. Unlike this, the current-type DC-DC converter may receive a direct current from a direct current source, or an inductor or other element is positioned between the power source and the switch unit 110 to receive the current through the switch unit 110. Since the current-type DC-DC converter is being inputted through other devices, the voltage being inputted may vary depending on the current size, so there are differences in the operation characteristics or necessary circuit elements when compared to a voltage-type DC-DC converter to which a voltage is constantly being inputted.

A DC-DC converter 100 according to an embodiment of the present invention may be used in a data center, and may be used in various fields requiring DC-DC converters, such as a vehicle LDC. DC-DC converters for data centers are used in power supply units (PSUs) for data centers to supply appropriate voltages to various electronic devices mounted in the data centers, and may be manufactured in an insulated type. DC-DC converters for data centers can usually be manufactured to specifications. For example, the height may be 4 cm, the width may be 7 cm, and the vertical width may vary according to required specifications. Since the size of the inductor among the elements comprising the data center DC-DC converter is larger than that of other elements, the size of the inductor can be reduced by using a DC-DC converter according to an embodiment of the present invention, thereby reducing the overall size of the DC-DC converter. In addition, even if the capacity of the DC-DC converter is increased, it is advantageous to manufacture it according to the standard, so the design freedom of a DC-DC converter can also be increased.

Hereinafter, each configuration of the DC-DC converter 100 according to an embodiment of the present invention will be described in detail.

The switch unit 110 receives a first DC voltage and separately outputs into three-phase voltages.

More specifically, the switch unit 110 may receive a first DC voltage. The first DC voltage may be inputted from the power supply 200. In this case, the power supply 200 may be a battery or an external power supply. The switch unit 110 receives the first DC voltage and separately outputs into three-phase voltages. As shown in FIG. 1, the input voltage may be outputted into three-phase voltages by dividing the input voltage into three instead of two. The switch unit 110 may include three switches. Through the three switches, the first DC voltage may be separated into three-phase voltages. The three switches are connected in parallel, and the first DC voltage may be divided into three-phase voltages according to the operation of each switch.

The transformation unit 120 transforms each of the three-phase voltages outputted from the switch unit 110 and outputs them as three-phase output voltages.

More specifically, the transformation unit 120 transforms each of the three-phase voltages outputted from the switch unit 110. The transformation unit 120 transforms each of the separated three-phase voltages according to a transformation ratio. The transformation unit 120 may reduce or boost the three-phase voltage. The first DC voltage is inputted from the outside, and when the second DC voltage is for a data center and being provided to another device, it is possible to perform step down for the voltage of the transformation unit 120. A transform ratio for transforming a voltage may vary depending on required specifications.

The transformation unit 120 may be formed of a transformer. The transformation unit 120 may have a primary coil and a secondary coil formed therein, and may convert the magnitude of the voltage using the principle of induced electromotive force generated between the primary coil and the secondary coil. When a voltage is applied to the primary coil, the strength and direction of the current are formed and the magnetic field around the primary coil changes, and as this magnetic field changes, the number of magnetic field lines (magnetic flux) changes, thereby generating an induced electromotive force in the secondary coil. The power of the primary and secondary coils is the same according to the law of conservation of energy, and since the number of turns on the coil is proportional to the voltage, the transform ratio can be formed differently according to the number of turns.

When the switch unit 110 includes three switches, the transformation unit 120 may include three input terminals and three output terminals respectively being connected to the three switches of the switch unit 110. Since the switch unit 110 is divided into three-phase voltages according to the operation of the three switches, it may include three input terminals receiving each voltage divided by the three-phase voltage. Each voltage input through the three input terminals may be transformed and outputted through the three output terminals, respectively.

Here, the transformation unit 120 may be implemented in the form of a three-phase Delta-Wye connection transformer. By receiving three voltages and performing transformation, each transformed voltage may be outputted. An embodiment in which the transformation unit 120 is implemented in the form of a Delta-Wye connection transformer will be described in detail later.

The rectification unit 130 rectifies each of the three-phase output voltages applied from the transformation unit 120 to output a second DC voltage.

More specifically, the rectification unit 130 outputs a second DC voltage by rectifying the three-phase output voltages respectively transformed and being outputted by the transformation unit 120. The rectification unit 130 rectifies the three-phase output voltage through rectification for converting an AC voltage into a DC voltage. That is, it converts alternating current, which periodically changes in magnitude and direction with time, into direct current, which does not change in size and direction with time, and flows constantly. The rectification unit 130 may be configured as a diode or a MOSFET switch.

The filter unit 140 may smooth the voltage outputted from the rectification unit 130 and output it as a DC voltage.

More specifically, the rectification unit 130 rectifies each three-phase output voltage to output a voltage, but may be output in the form of an AC voltage rather than a DC voltage that is constantly maintained according to the operation of the switch unit 110. Accordingly, the filter unit 140 may be included to smooth the voltage outputted from the rectification unit 130 to output a second DC voltage maintaining a constant voltage level. In this case, the filter unit 140 may include one or more inductors and one or more capacitors. The inductor may be connected in series with the rectification unit 130, and the capacitor may be connected in parallel with the rectification unit 130. Here, the inductor and the capacitor may operate as an LC filter to smooth the voltage outputted from the rectification unit 130 to output a second DC voltage. Through this, it is possible to output and provide a stable voltage to the load 300.

A DC-DC converter according to an embodiment of the present invention may be implemented as shown in FIG. 4.

The switch unit 110 may receive a first DC voltage from the power supply 200 as shown in FIG. 4. The switch unit 110 may be implemented with six switches and output the first DC voltage by separating into three-phase voltages. The switch unit 110 includes a first switch, a second switch and a third switch connected in parallel, and a fourth switch connected to the first switch, a fifth switch connected to the second switch, and a sixth switch connected to the third switch. A first switch, a second switch, and a third switch among the six switches are connected in parallel; the first switch and the fourth switch are connected; the second switch and the fifth switch are connected; and the third switch and the sixth switch are connected, thereby dividing the first DC voltage into a three-phase voltage and outputting them to the transformation unit 120. Two switches connected to each other may form a half bridge, and each half bridge may allow each voltage forming a three-phase voltage to be input to the transformation unit 120. Since the voltage of each switch is clamped to the first DC voltage, a separate clamp circuit is not required.

The transformation unit 120 is formed of three input terminals, three transformers, and three output terminals, as shown in FIG. 4, respectively, receiving three-phase voltages, transforming them, and outputting them. In the transformation unit 120, three input terminals are connected in the form of a Delta (Δ) connection. That is, the three input terminals connect the connecting lines to be the input of each transformer and the output of the other transformer so that the primary input of each transformer is formed to be a Delta connection. The three output terminals of the transformation unit 120 are Y-connected unlike the three input terminals connected in the form of a Delta connection. The three output terminals connect the connecting lines so that they are respectively connected to the input or output of each transformer, so that the secondary output of each transformer is formed to be a WYE connection. Accordingly, the transformation unit 120 may be referred to as a Delta-Wye (Δ-Y) transformer.

The voltage transformed in the transformation unit 120 and outputted through the output terminal is rectified in the rectification unit 130, and the rectification unit 130 may include three rectifiers 131 to 133 being connected to each of the output terminals of the transformation unit 120 and one node 134 to which the output terminals of the three rectifiers 131 to 133 are being connected. Each of the rectifiers 131 to 133 may receive and rectify three output voltages transformed by the transformation unit 120 and being outputted to three output terminals, respectively. The voltages rectified by each of the rectifiers 131 to 133 are combined and outputted from one node 134.

The voltage being outputted from the node 134 of the rectification unit may be smoothed through the filter unit 140 and outputted as a DC voltage. Here, the filter unit 140 may be an LC filter including an inductor 141 and a capacitor 142. The second DC voltage smoothed through the filter unit 140 may be provided to the load 300.

The DC-DC converter according to an embodiment of the present invention may be implemented in various ways in the form of the circuit of FIGS. 5 to 8. FIGS. 5 to 8 are illustrated by way of example, and it is of course that other types of circuits may be used.

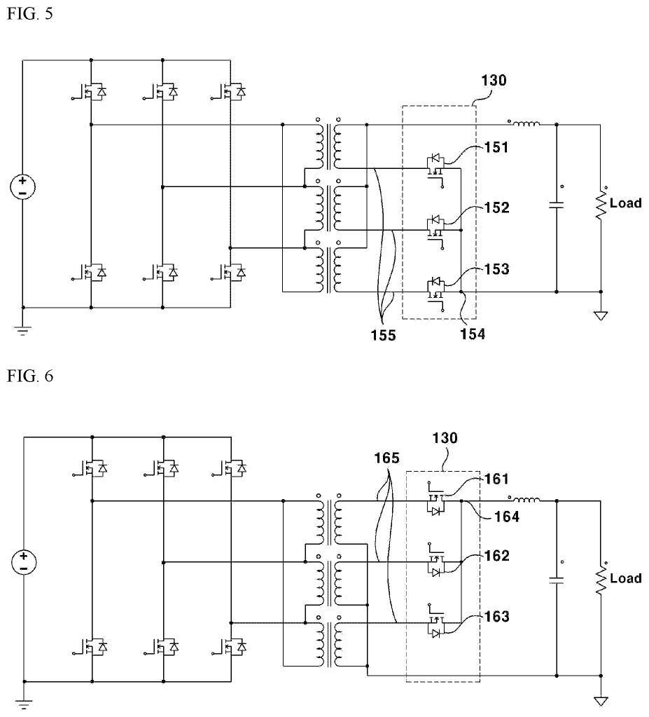

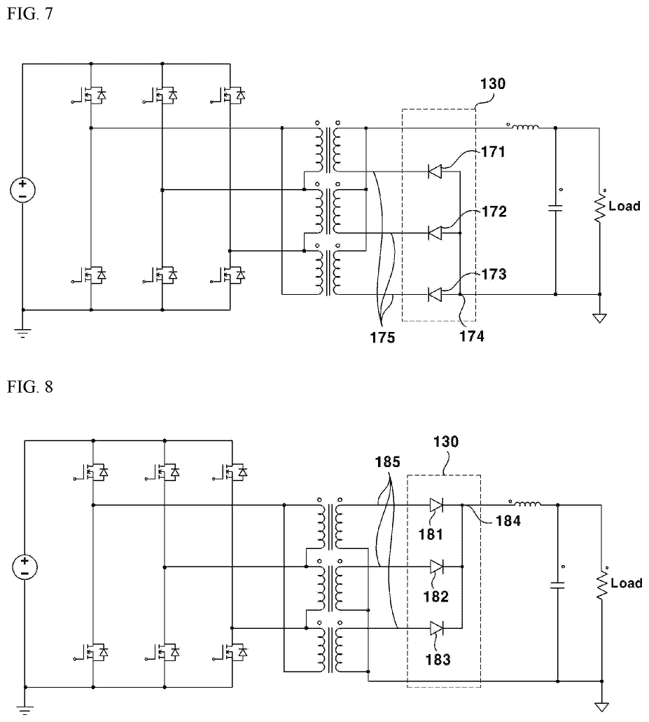

The rectification unit 130 is implemented with three rectifiers, and as shown in FIGS. 5 and 6, may be implemented as a MOSFET, or as a diode as shown in FIGS. 7 and 8. In addition, each rectifier may be respectively connected to each of the (−) terminals at the output side of the transformation unit 120, as shown in FIGS. 5 and 7, or as shown in FIGS. 6 and 8, may be respectively connected to each of the (+) terminal at the output side of the transformation unit.

FIG. 5 illustrates an embodiment in which the rectifier comprising the rectification unit 130 is implemented with three MOSFETs 151 to 153, and each MOSFET is connected to each of the (−) terminals at the output side of the transformation unit 120. When the transformation unit is comprised of three transformers, each transformer is comprised of (+) and (−) terminals of the input side which is the primary side and (+) and (−) terminals of the output side which is the secondary side. The rectifier is formed at the output side, but can be formed on the (+) terminal or the (−) terminal, and when using a MOSFET as a rectifier, when it is formed on the (−) terminal at the output side due to the structure of the MOSFET, since it can be formed as a common source, it is structurally simple to form a MOSFET on the (−) terminal at the output side. In addition, when using a MOSFET as a rectifier than when using a diode, the loss is low and the efficiency is high, so it is advantageous, as shown in FIG. 5, it may be desirable to connect three MOSFETs to the (−) terminal at the output side of each transformer. In this way, when the rectification unit 130 is implemented, the node 154 in which the rectified voltages from the three rectifiers are combined is also formed on the (−) terminal side. Accordingly, the source of each MOSFET is combined into one terminal, and is formed as a common source. The combined voltage is outputted as a DC voltage through the filter.

FIG. 6 is a rectifier comprising the rectification unit 130 is implemented with three MOSFETs 161 to 163, and illustrates an embodiment in which each MOSFET is connected to each of the (+) terminals at the output side of the transformation unit 120. The three MOSFETs 161 to 163 are respectively connected to three (+) terminals at the output side of the transformation unit, and are combined at the terminal 164 to output a voltage. Since the drain of each MOSFET is combined into one terminal, it is formed as a common drain.

As shown in FIGS. 5 and 6, a diode, not a MOSFET, may be used as a rectifier comprising the rectification unit 130. First, as shown in FIG. 7, the rectifier comprising the rectification unit 130 is implemented with three diodes 171 to 173, and each diode may be respectively connected to each of the (−) terminals at the output side of the transformation unit 120. At this time, since the anode of each diode is combined into one terminal, it is formed as a common anode.

Or, as shown in FIG. 8, the rectifier comprising the rectification unit 130 is implemented with three diodes 181 to 183, and each diode may be respectively connected to each of the (+) terminals at the output side of the transformation unit 120. At this time, since the cathodes of each diode are combined into one terminal, they are formed as a common cathode.

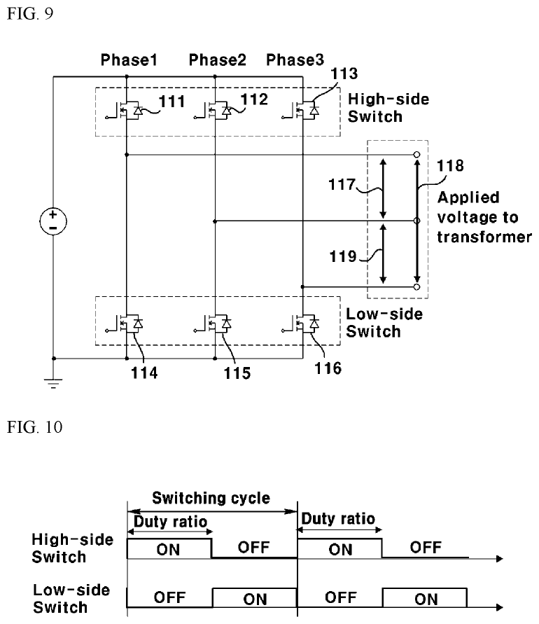

The switch unit 110 may be implemented with six switches, and the first switch and the fourth switch, the second switch and the fifth switch, and the third switch and the sixth switch may be complementarily conducted to each other. As shown in FIG. 9, when the switch unit 110 comprises with six switches 111 to 116, the first switch 111 and the fourth switch 114 may be connected to each other to comprise one half-bridge circuit, and the second switch 112 and the fifth switch, the third switch 113 and the sixth switch may also respectively comprise a half-bridge circuit. The entire circuit using three half-bridge circuits can be expressed as a full-bridge circuit. At this time, the first switch 111, the second switch 112, and the third switch 113 are high-side switches on each half-bridge circuit, and the fourth switch 114 and the fifth switch 115, and the sixth switch 116 may operate as low-side switches.

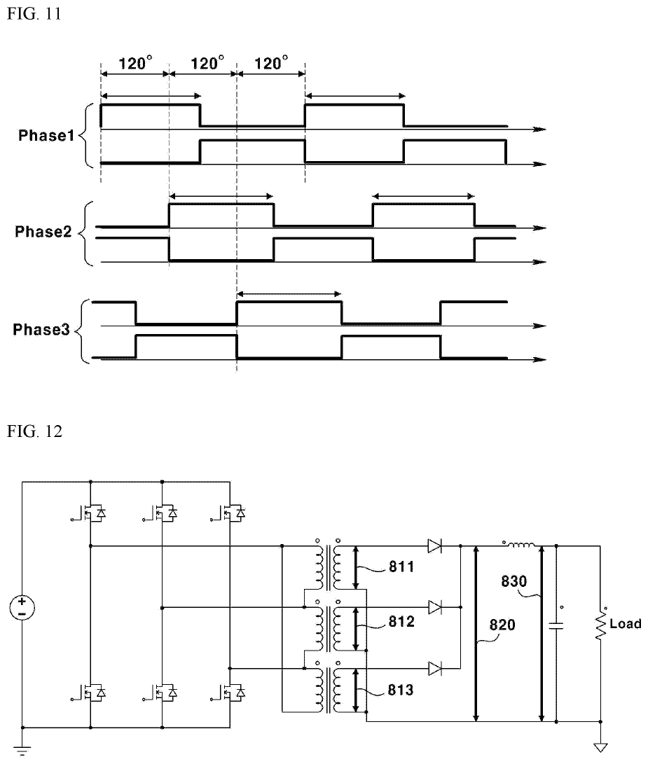

The switch unit 110 controls the duty ratio so that the first switch and the fourth switch, the second switch and the fifth switch, and the third switch and the sixth switch can be complementarily conducted to each other. The high-side switch and the low-side switch comprising one half-bridge circuit are paired and may be complementarily conducted to each other as shown in FIG. 10. At this time, by controlling the duty ratio of each switch, they may be complementarily conducted to each other. Here, the duty ratio is the ratio of the time when the current flows to the time when the current does not flow, and in the case of a switch, it means the ratio of turning on, and the duty ratio is also referred to as a duty cycle. That is, the duty ratio of each switch can be controlled so that when the high-side switch is turned on, the low-side switch is turned off, and when the high-side switch is turned off, the low-side switch is turned on. The time between the time point when the switch is turned ON and turned OFF and the time point when it is turned ON again can be viewed as one switching cycle.

Each switch of the switch unit 110 may have a different phase. Two switches that are paired to form a half-bridge circuit are complementarily conducted, and at the same time, switches that are connected to one another and form one pair may have different phases phase 1, phase 2, and phase 3 from the switches forming another pair. As shown in FIG. 11, each pair of switches having different phases may have a phase difference of 120 degrees from one another, and through this, the first DC voltage may be divided into three-phase voltages and outputted.

The switch unit 110 may vary the voltage width applied to the transformation unit by controlling the duty ratio of each switch. The voltages separated into three-phase voltages in the switch unit 110 and being applied to each transformer forming the transformation unit is the same as the voltages between the input terminals. That is, the applied voltage applied to the primary side of the transformer may be expressed as 117, 118, and 119, as shown in FIG. 9. The voltage of the secondary side of the transformer outputted after being applied to each transformer and transformed may be expressed as 811, 812, and 813 as shown in FIG. 12. The voltage combined at the node of the rectification unit is equal to 820, and the second DC voltage smoothed through the filter unit is equal to 830.

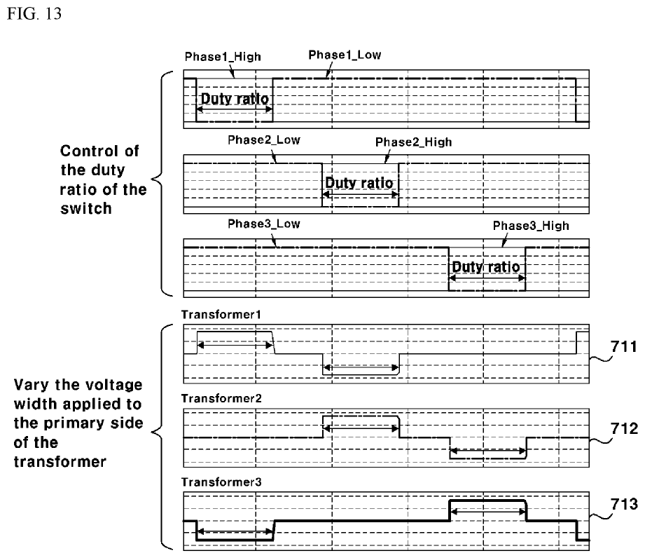

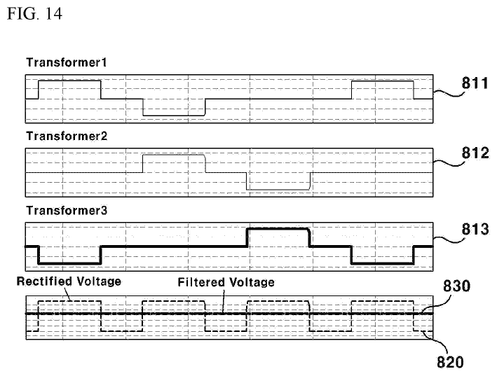

When the duty ratio of each switch is controlled, the voltage width applied to the primary side of the transformer can be varied. In addition, the switch unit 110 may control the duty ratio of each switch to vary the current voltage value outputted by the DC-DC converter. In the case of controlling the duty ratio at which the high-side switch of the pair of switches is ON, as shown in FIG. 13, the voltage applied to the primary sides of the transformers 1 to 3 shows the voltage waveforms such as 711 to 713. In this way, the secondary voltage that is a voltage applied to the primary side and transformed in each transformer, and outputted from each of the three output terminals, has the same voltage waveforms as 811 to 813 of FIG. 14. The voltage which is a rectified voltage through the rectifier connected to the three output terminals of the transformation unit 120 is the same as 820 in FIG. 14, and the second DC voltage, which is the filtered voltage that has passed through the LC filter, is the same as 830 of FIG. 14.

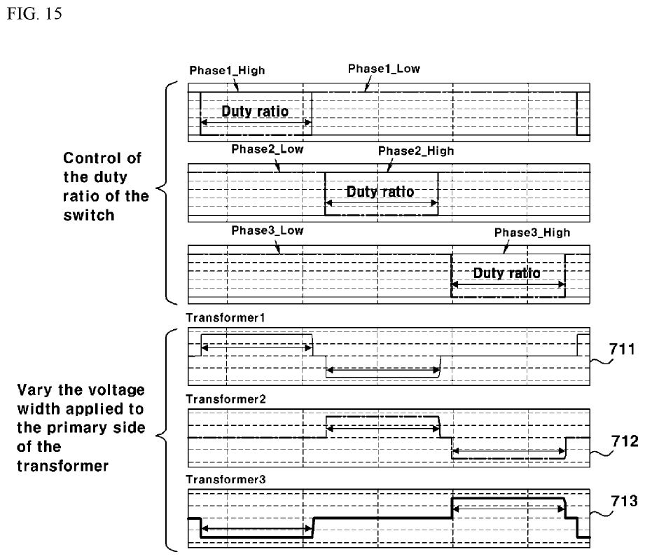

Unlike FIG. 13, when the duty ratio is differently controlled as shown in FIG. 15, the voltage applied to the primary side of the transformer has the same voltage waveforms as 711 to 713 of FIG. 15. It can be seen that, unlike the voltage applied to the primary side of FIG. 13, a section having a predetermined voltage is large. Accordingly, the voltages of the secondary side that are transformed in each transformer and being outputted from the three output terminals, respectively, have waveforms such as 811 to 813 of FIG. 15; the rectified voltage is the same as 820 in FIG. 15; and the filtered second DC voltage is the same as 830 of FIG. 15. It can be seen that the filtered second DC voltage of FIG. 15 is greater than the filtered second DC voltage of FIG. 13.

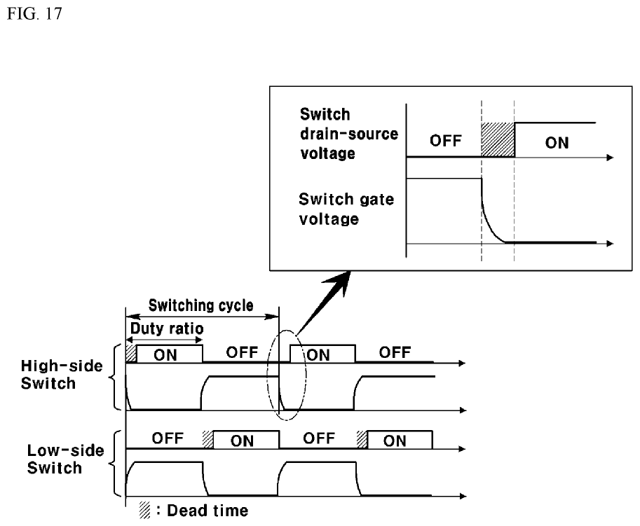

Each switch of the switch unit 110 may have a predetermined dead time when switching from OFF to ON. When a pair of switches are conducted complementarily, when one switch is shifted from OFF to ON, the other switches are switched from ON to OFF. When the switch is switched from ON to OFF, the voltage value fluctuates rapidly, which can cause large switching losses; the voltage may not be changed from the predetermined voltage corresponding to ON to 0 V immediately; and the voltage may become 0 V only after a predetermined period has elapsed. In particular, when a MOSFET is used as a switch, the switch is turned ON and OFF using the switch gate voltage, even if the gate voltage of the switch is turned off, it takes a certain amount of time for the voltage generated between the drain and the source to become 0 V. As such, when a residual voltage exists, a switching loss may occur, and a switching error may also occur, thereby reducing the efficiency or accuracy of transforming the voltage. In order to reduce such an error, as shown in FIG. 17, when controlling the switch from OFF to ON, a predetermined time interval may be applied until the voltage applied to the other pair of switches becomes 0 V. That is, a dead time is applied in which both switches which are being complementarily conducting for a predetermined time are put to an OFF state. During this dead time, a zero-voltage switching (ZVS) is performed. By performing zero voltage switching during the dead time, switching loss can be reduced and switching accuracy can be improved.

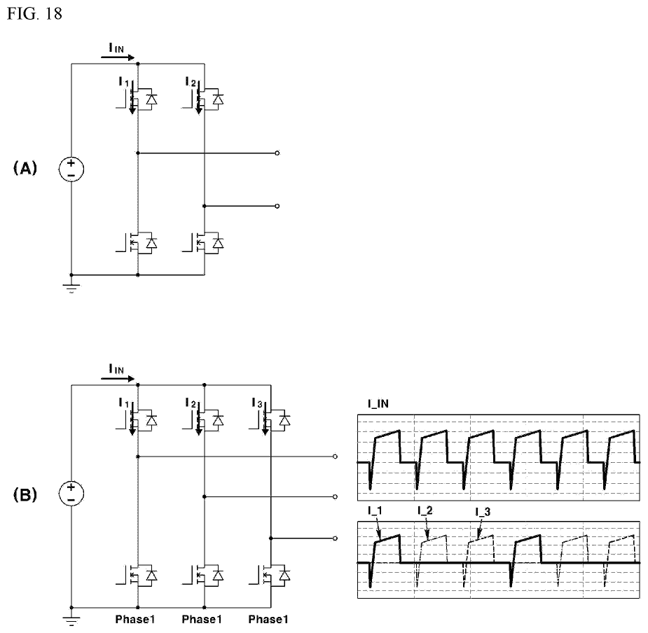

In the case of the DC-DC converter 10 of FIG. 1, the input current flows divided into two switches as shown in FIG. 18(A), but the input current of the DC-DC converter 100 according to an embodiment of the present invention is divided into three switches as shown in FIG. 18(B) and flows, current stress of each switch can be reduced. Accordingly, a switch having a lower capacity or specification than the switch being used in the DC-DC converter 10 of FIG. 1 may be used.

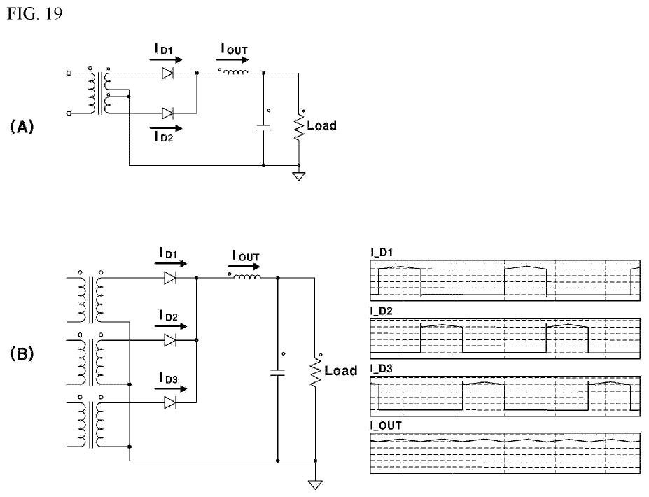

The output current also flows in the case of the DC-DC converter 10 of FIG. 1, the output current is being divided into two to flow through the two rectifiers as shown in FIG. 19(A), but the output current of the DC-DC converter 100 according to an embodiment of the present invention is being divided into three to flow through the three rectifiers as shown in FIG. 19(B), so that the current stress of each rectifier can be reduced.

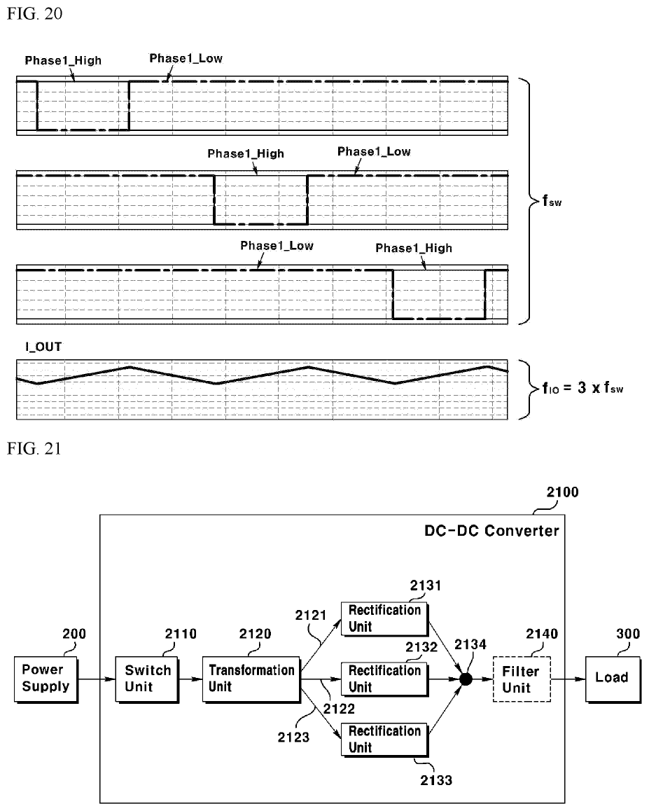

In the case of the DC-DC converter 10 of FIG. 1, the output inductor being connected to the output side operates at twice the switching frequency, but DC-DC converter 100 according to an embodiment of the present invention, as shown in FIG. 20, can be operated at 3 times the switching frequency fsw (f1O=3×fsw). Accordingly, the inductor can be operated at a high frequency even at a lower switching frequency than the DC-DC converter 10 of FIG. 1. Accordingly, the size of the output inductor can be reduced.

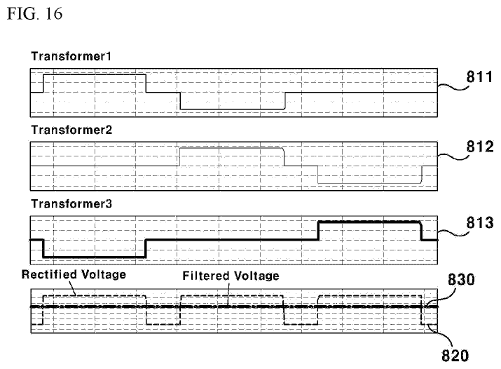

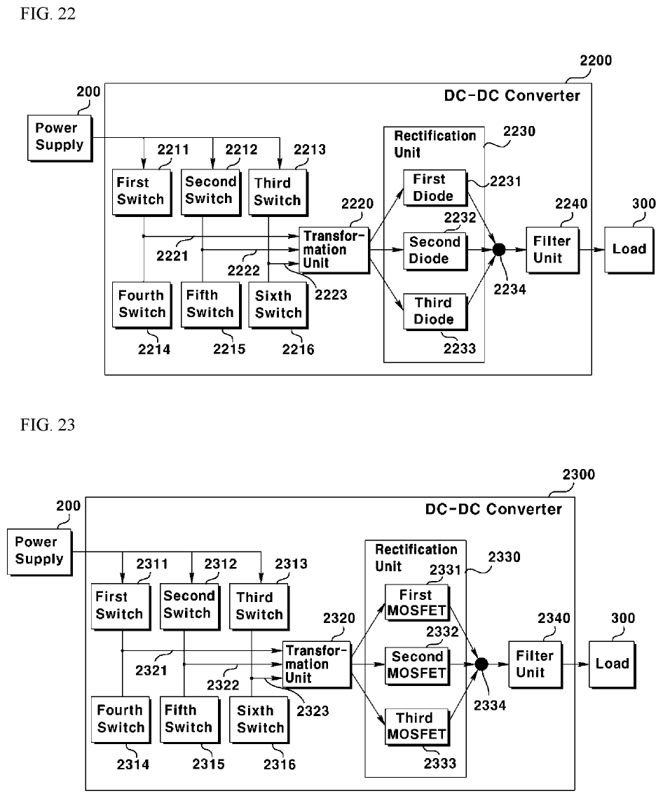

FIGS. 21 to 23 are block diagrams of a DC-DC converter according to another embodiment of the present invention. FIG. 21 is a block diagram of a DC-DC converter 2100 according to another embodiment of the present invention; FIG. 22 is a block diagram of a DC-DC converter 2200 including a plurality of switches and a plurality of diodes; and FIG. 23 is a block diagram of a DC-DC converter 2300 including a plurality of switches and a plurality of MOSFETs. The detailed description of the DC-DC converter 2100, the DC-DC converter 2200, or the DC-DC converter 2300 corresponds to the detailed description of the DC-DC converter 100 described with reference to FIGS. 1 to 20. Therefore, overlapped descriptions other than the configuration different from the DC-DC converter 100 described above will be omitted.

A DC-DC converter 2100 according to another embodiment of the present invention includes, as shown in FIG. 21, a switch unit 2110, a transformation unit 2120 being connected to the switch unit 2110, and rectification units 2131 to 2133 being connected to the transformation unit 2120. The switch unit 2110 includes three switches; the transformation unit 2120 includes three input terminals and three output terminals being respectively connected to the three switches; the rectification unit includes three rectifiers 2131 to 2133 being connected to each of the output terminals of the transformation unit 2120; and one node 2134 to which the output terminals of the three rectifiers are being connected. A filter unit 2140 may be further included.

DC-DC converter 2200 according to yet another embodiment of the present invention, as shown in FIG. 22, comprises: a first switch 2211, a second switch 2212, and a third switch 2213 being connected in parallel; a fourth switch 2214 being connected to the first switch 2211; a fifth switch 2215 being connected to the second switch 2212; a sixth switch 2216 being connected to the third switch 2213; a transformation unit 2220 comprising: a first input terminal 2221 being connected to the first switch 2211 and the fourth switch 2214; a second input terminal 2222 being connected to the second switch 2212 and the fifth switch 2215; a third input terminal 2223 being connected to the third switch 2213 and the sixth switch 2216; a rectification unit 2230 being connected to the transformation unit 2220; and a filter unit 2240 being connected to the rectification unit 2230, wherein the rectification unit 2230 includes three diodes 2231 to 2233 being connected to an output terminal of the transformation unit 2220, and wherein the filter unit 2240 includes one input terminal 2234 being connected to the three diodes.

DC-DC converter 2300 according to yet another embodiment of the present invention, as shown in FIG. 23, comprises: a first switch 2311, a second switch 2312, and a third switch 2313 being connected in parallel; a fourth switch 2314 being connected to the first switch 2311; a fifth switch 2315 being connected to the second switch 2312; a sixth switch 2316 being connected to the third switch 2313; a transformation unit 2320 comprising: a first input terminal 2321 being connected to the first switch 2311 and the fourth switch 2314; a second input terminal 2322 being connected to the second switch 2312 and the fifth switch 2315; a third input terminal 2323 being connected to the third switch 2313 and the sixth switch 2316; a rectification unit 2330 being connected to the transformation unit 2320; and a filter unit 2340 being connected to the rectification unit 2330, wherein the rectification unit 2330 includes three MOSFETs 2331 to 2333 being connected to an output terminal of the transformation unit 2320, and wherein the filter unit 2340 includes one input terminal 2334 being connected to the three MOSFETs.

As described above, in the present invention, specific matters such as specific components, and the like; and limited embodiments and drawings have been described, but these are only provided to help a more general understanding of the present invention, and the present invention is not limited to the above embodiments, and various modifications and variations are possible from these descriptions by those of ordinary skill in the art to which the present invention belongs.

Therefore, the spirit of the present invention should not be limited to the described embodiments, and not only the claims to be described later, but also all those with equivalent or equivalent modifications to the claims will be said to belong to the scope of the spirit of the present invention.

1. A DC-DC converter comprising:
a switch unit configured to receive a first DC voltage which is to be separated and outputted as three-phase voltages;
a transformation unit configured to respectively transform the three-phase voltages outputted from the switch unit to outputs as three-phase output voltages; and
a rectification unit configured to respectively rectify the three-phase output voltages being applied from the transformation unit to output a second DC voltage.

2. The DC-DC converter according to claim 1, further comprising:
a filter unit configured to smooth the second DC voltage outputted from the rectification unit.

3. The DC-DC converter according to claim 1,
wherein the rectification unit comprises three rectifiers respectively connected to output terminals of the transformation unit and one node to which output terminals of the three rectifiers are being connected.

4. The DC-DC converter according to claim 3,
wherein each of the rectifiers is respectively connected to each of (+) terminals at an output side of the transformation unit.

5. The DC-DC converter according to claim 1,
wherein the rectification unit comprises one or more diodes or one or more MOSFETs.

6. The DC-DC converter according to claim 1,
wherein the switch unit comprises three switches, and
wherein the transformation unit comprises three input terminals and three output terminals being respectively connected to the three switches.

7. The DC-DC converter according to claim 1,
wherein the switch unit comprises a first switch, a second switch and a third switch connected in parallel; and
a fourth switch connected to the first switch, a fifth switch connected to the second switch, and a sixth switch connected to the third switch.

8. The DC-DC converter according to claim 1,
wherein the switch unit varies current and voltage values outputted from the DC-DC converter by controlling duty ratio of each switch.

9. The DC-DC converter according to claim 1,
wherein each switch of the switch unit has a predetermined dead time when it is switched from OFF to ON.

10. The DC-DC converter according to claim 1,
wherein each switch of the switch unit has a different phase.

11. The DC-DC converter according to claim 7,
wherein the first switch and the fourth switch, the second switch and the fifth switch, and the third switch and the sixth switch is complementarily conducted to each other.

12. The DC-DC converter according to claim 7,
wherein the first switch and the fourth switch, the second switch and the fifth switch, and the third switch and the sixth switch is complementarily conducted to each other by controlling duty ratio.

13. The DC-DC converter according to claim 1,
wherein the switch unit varies a voltage width being applied to the transformation unit by controlling a duty ratio of each switch.

14. The DC-DC converter according to claim 1,
wherein the DC-DC converter may be a voltage-type DC-DC converter.

15. The DC-DC converter according to claim 1,
wherein the filter unit comprises one or more inductors and one or more capacitors.

16. The DC-DC converter according to claim 3,
wherein each of the rectifiers is respectively connected to each of (−) terminals at an output side of the transformation unit.

17. A DC-DC converter comprising:
a switch unit;
a transformation unit connected to the switch unit; and
a rectification unit connected to the transformation unit,
wherein the switch unit comprises three switches,
wherein the transformation unit comprises three input terminals and three output terminals respectively being connected to the three switches, and
wherein the rectification unit comprises three rectifiers being connected to each of the output terminals of the transformation unit and one node to which the output terminals of the three rectifiers are being connected.

18. The DC-DC converter according to claim 17,
wherein the switch unit varies current and voltage values outputted from the DC-DC converter by controlling duty ratio of each switch.

19. The DC-DC converter according to claim 17,
wherein each switch of the switch unit has a predetermined dead time when it is switched from OFF to ON.

20. A DC-DC converter comprising:
a first switch, a second switch and a third switch connected in parallel;
a fourth switch connected to the first switch, a fifth switch connected to the second switch, and a sixth switch connected to the third switch;
a transformation unit comprising a first input terminal being connected to the first switch and the fourth switch, a second input terminal being connected to the second switch and the fifth switch, and a third input terminal being connected to the third switch and the sixth switch;
a rectification unit connected to the transformation unit; and
a filter unit connected to the rectification unit,
wherein the rectification unit comprises three MOSFETs being connected to an output terminal of the transformation unit, and
wherein the filter unit comprises one input terminal being connected to the three MOSFETs.
